(19) United States
(12) Patent Application Publication
(10) Pub. No.: US 2008/0105761 A1
(43) Pub. Date: May 8, 2008

(54) INTERIOR AND EXTERIOR CLEANING OF WASTE CARTS AND CONTAINERS

(75) Inventors: Pierre J. Amestoy, Albuquerque, NM (US); Ernest F. Byers, Albuquerque, NM (US)

Correspondence Address: PEACOCK MYERS, P.C., 201 THIRD STREET, N.W., SUITE 1340, ALBUQUERQUE, NM, 87102, US

(73) Assignee: BLAST N CLEAN LLC, Albuquerque, NM (US)

(21) Appl. No.: 11/929,739

(22) Filed: Oct. 30, 2007

Related U.S. Application Data
(63) Continuation-in-part of application No. 11/697,208, filed on Apr. 5, 2007.
Application No. 11/697,208 is a continuation-in-part of application No. 11/681,717, filed on Mar. 2, 2007, now abandoned.
Application No. 11/681,717 is a continuation-in-part of application No. 11/458,358, filed on Jul. 18, 2006.
Application No. 11/458,358 is a continuation-in-part of application No. 11/212,276, filed on Aug. 25, 2005, now Pat. No. 7,225,816.
(60) Provisional application No. 60/604,539, filed on Aug. 25, 2004.

(51) Int. Cl. B05B 9/03; B08B 9/00

(52) U.S. Cl. 239/146; 134/170

(57) ABSTRACT

A mobile or stationary waste cart or container cleaning system used for residential, commercial and industrial waste, garbage, trash, storage or operations containers or receptacles. Other applications include, but are not limited to cleaning of chemical drums, grease dumpsters (e.g. behind restaurants), rain barrels and non-uniform residential, commercial or industrial dumpsters or waste containers. The container cleaning system can alternatively be used for rural areas, farms or ranches. The system sprays the interior and exterior of the container.

### CROSS-REFERENCE TO RELATED APPLICATIONS

This application is a continuation-in-part of U.S. patent application Ser. No. 11/697,208 entitled “Automatic Cart and Container Cleaning and Valve System,” filed Apr. 5, 2007; which is a continuation application of U.S. patent application Ser. No. 11/681,717 entitled “Automatic Cart and Container Cleaning and Valve System,” filed Mar. 2, 2007 (abandoned); which is a continuation-in-part application of U.S. patent application Ser. No. 11/458,358, entitled “Automated Cart and Container Cleaning System,” filed on Jul. 18, 2006; which is a continuation-in-part application of U.S. patent application Ser. No. 11/212,276, entitled “Waste Container Cleaning System,” filed on Aug. 25, 2005, issued as U.S. Pat. No. 7,225,816, which claims priority to U.S. Provisional Patent Application Ser. No. 60/604,539, entitled “Mobile Waste Can Cleaning System,” filed on Aug. 25, 2004.

### BACKGROUND OF THE INVENTION

1. Field of the Invention (Technical Field)

The present invention relates to the interior and exterior cleaning of waste carts, containers, and receptacles, preferably used for residential and commercial waste, garbage, or trash.

2. Description of Related Art

Residential and commercial waste containers can collect wastes and pests throughout the course of their use. Cleaning and maintenance of these waste containers can be time consuming and difficult, not to mention dangerous depending on the waste or residue. Often these containers are not cleaned regularly which can lead to worse health and environmental problems, especially in areas of dense populations.

The present invention provides for the exterior and interior washing and cleaning of containers.

### BRIEF SUMMARY OF THE INVENTION

The present invention relates to a waste container cleaning system to provide a sanitary, efficient and cost effective apparatus and method for preferably cleaning the interior and exterior of commercial and industrial garbage containers.

The present invention preferably is a spraying system for spraying a cart or container comprising: a fluid spray system for spraying the cart or container, the spray system spraying both an inside and an outside of the cart or container; and a system for lifting and inverting the cart or container over said fluid spray system. Preferably the present invention is on a mobile vehicle and comprises the spraying system and a transportable base.

The present invention preferably has a switch for operating said spraying system in the cab of the vehicle. This switch can be manually or automatically activated.

The present invention preferably sprays the inside and the outside of the cart or container simultaneously. Alternatively the spraying of the inside and outside of the cart or container is in series. After spraying the cart or container, the present invention preferably has a system for lifting and inverting comprises a system for returning the cart or container to its approximate original location.

The lid of the cart or container is lifted preferably with a lid lifter and is also sprayed.

The present invention includes but is not limited to a method for spraying a cart or container comprising: lifting and inverting a cart or container over a fluid spray system; and spraying the cart or container, wherein the spray system sprays the inside and an outside of the cart or container.

The present invention is disposed on a mobile vehicle comprising a transportable base and a switch is disposed in a cab of the vehicle allowing initiation of the spraying with the switch. The switch can be manually or automatically activated.

The method of the present invention includes but is not limited to spraying the inside and the outside of the cart or container simultaneously or in series.

The present invention preferably comprises a lid lifter to lift the lid and the lid is preferably cleaned by spraying the lid of the cart or container with the spray system. After cleaning of the cart or container, the present invention preferably includes but is not limited to returning the cart or container to its approximate original location.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a side view of an embodiment of the invention on a modified garbage truck or other vehicle;

FIG. 2 is a side perspective view of a spray head with spray nozzles on a rotatable coupling;

FIG. 3 is a side view of an inverted waste container over a waste container cleaning system;

FIG. 4 is a top perspective view of a spray cleaning system;

FIG. 5 is a top view schematic of an embodiment of the invention;

FIG. 6 is a side perspective view of a loading arm, knuckle and waste container;

FIG. 7 is a rear perspective view of the loading arm;

FIG. 8 is a top view of a conveyor system of the present invention with a cleaning brush and residue basin;

FIG. 9 is a side view of a front loading embodiment of the invention;

FIG. 10 is a side view of a rear loading embodiment of the present invention;

FIG. 11 is a side perspective view of an alternative two-headed nozzle and spray head embodiment of the present invention;

FIG. 12 is a side view of a shut-off switch of the FIG. 11 embodiment;

FIG. 13 is a side view of the pop-off valve of the FIG. 11 embodiment;

FIG. 14 is a top view of a solenoid of the FIG. 11 embodiment;

FIG. 15 is a side view of a lid lifter and a spray head protector of the FIG. 11 embodiment;

FIG. 16 is a top view of an overflow filtration system of the FIG. 11 embodiment; and

FIG. 17 is a side view of a system to wash the inside and outside of a container.

### DETAILED DESCRIPTION OF THE INVENTION

The present invention is a method and apparatus for waste container cleaning which is preferably used to clean residential (e.g. 35 gallons to 350 gallons) or commercial or industrial (e.g. 1 cubic yard to 10 cubic yards) garbage containers. Embodiments of the invention can be used for either residential, commercial or industrial waste containers. The cleaning system preferably comprises a mobile system, including but not limited to a truck or vehicle separate from the regularly scheduled garbage truck. The waste container cleaning system is preferably a mobile vehicle with an engine, but can be stationary. The mobile system is preferably a separate modified garbage truck or other vehicle. The vehicle is preferably a side loading truck but alternatively may be a front loading truck or a rear loading truck or vehicle.

An embodiment of the invention is a side loading vehicle with a side loading arm that has been modified to invert a waste container 180 degrees. Alternatively, the waste container is inverted to less than 180 degrees, but preferably more than 150 degrees. The cleaning cycle is preferably several seconds (between approximately 6 seconds and approximately 15 seconds) and most preferably less than six (6) seconds so that the vehicle is able to follow a garbage truck along a regularly scheduled route and clean the waste containers after being dumped by the garbage truck.

As used throughout the specification and claims the terms “cart” “container” or “receptacle” is intended to include any residential, commercial or industrial apparatus or device which is capable of containing waste materials, debris or other items, and includes but is not limited to a receptacle, trash container, industrial container, garbage can, cart, and dumpster.

As used throughout the specification the term “pests” is intended to include any materials or organisms that may corrupt the container, including but not limited to fungi, bacteria, and odors.

The term “filter” as used throughout the specification and claims is defined as a separator and includes but is not limited to materials, electronics, or any item that is appropriate to separate one component from another.

As used throughout the specification and claims the term “fluid” is intended to include any fluid material, including but not limited to a solid, semi-solid, powder, liquid or vapor. A fluid also includes but is not limited to cold fluid, hot fluid, steam, chemicals, liquids, solids, semi-solids, gases, chemicals, oils, granules and sprays.

As used throughout the specification and claims the term “detergent” means a soap or cleaning substance and also may comprise any antibacterial, antiviral, and/or sanitary agent.

As used throughout the specification and claims, the term “guide” refers to but is not limited to anything which helps to direct the course or determine the direction of traveling of the waste container over the spray system so that the spray system is not damaged.

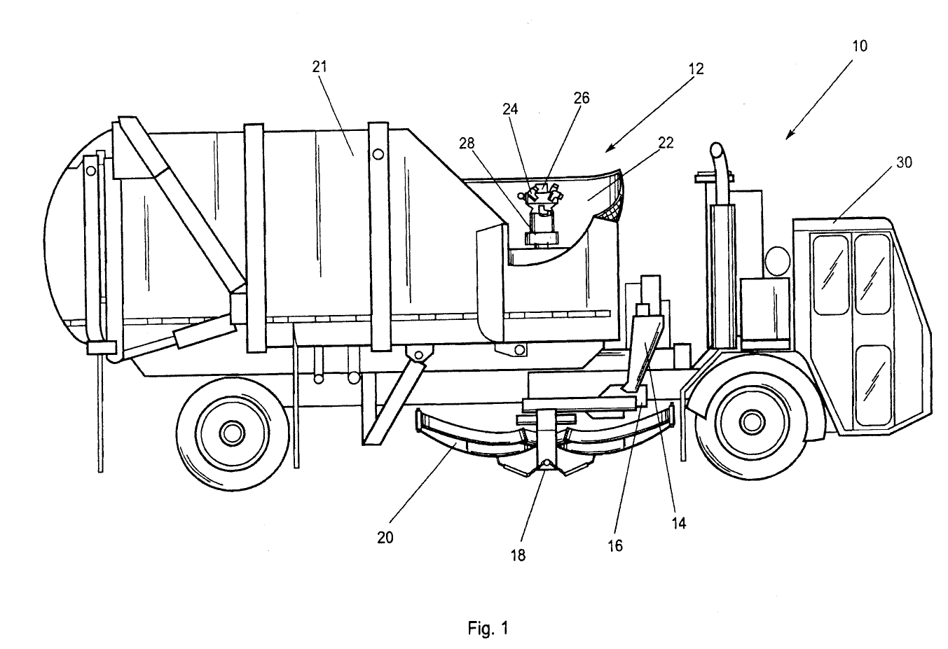

The drawings show alternative embodiments of the invention. As shown therein, FIG. 1 is a side view of an embodiment of the invention. Vehicle 10 is preferably a vehicle or modified garbage truck where containment shell 21 has been “hollowed” and modified to fit in the system components. A portion of containment shell 21 has been cut away 12 in the area of the front of the truck, behind the cab, which preferably houses the front portion of the cleaning system. Preferably, a driver in cab 30 sees a waste container on a curb and pulls up next to the curb. The driver preferably operates arm 14, 16 and knuckle 18, 20 remotely through a system control box inside of cab 30. Once extended the driver uses arm 14, 16 and knuckle 18, 20 to grab, lift and invert the waste container over the front portion of the cleaning system. The inverted container is spray cleaned with a fluid and then the operator sets down the waste container using arm 14, 16 and knuckle 18, 20.

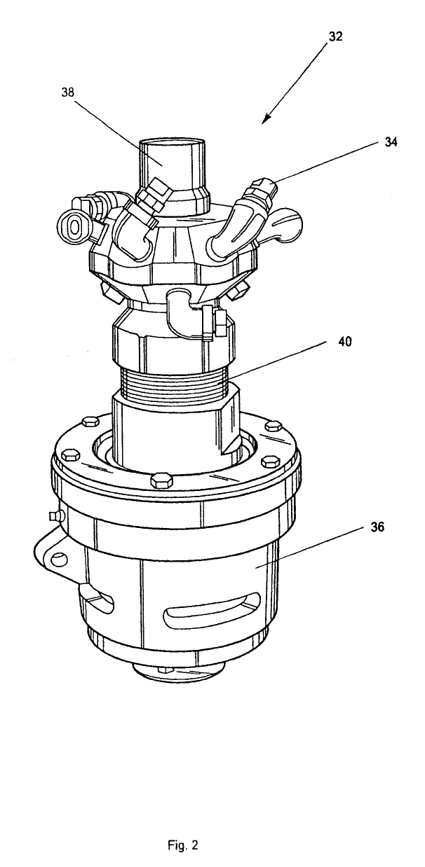

FIG. 1 also shows a spray cleaning system of the invention which includes but is not limited to hopper or catch basin 22, and directional spray nozzles 24 disposed on spray head 26 which is disposed on rotatable coupling 28. FIG. 1 shows the complete spray cleaning system which is an in-series water system. FIGS. 2-5 show additional views of the spray cleaning system and its components.

The waste container cleaning system has a fluid spray system which has at least one rotatable coupling, holding at least one spray head. Directional spray nozzle(s) are preferable. The spray head(s) are preferably on a rotatable coupling, and the spray head(s) and spray nozzle(s) may be stationary or rotating. The spray cleaning method includes but is not limited to passing a clean fluid through at least one spray nozzle on at least one spray head on at least one rotatable coupling, and spraying the inverted container with the clean fluid. The rotating head may also oscillate in any direction and with any speed. The preferred embodiment is a chain driven mechanism but alternatively any mechanism capable of driving rotational unit may be used. The rotational speed is preferably between approximately 5 rpm and approximately 500 rpm per head. The rotational speed is more preferably between approximately 10 rpm and approximately 200 rpm, and most preferably between approximately 20 rpm and approximately 70 rpm. Each nozzle preferably uses a high impact spray pattern that is preferably between approximately zero degrees and approximately 100 degrees, more preferably between approximately 2 degrees and approximately 75 degrees, and most preferably between approximately 5 degrees and approximately 60 degrees. The spray is preferably between approximately 1 gallons per minute and 50 gallons per minute. The spray head pressure is preferably between approximately 5 psi and approximately 2,000 psi, more preferably between approximately 10 psi and approximately 1500 psi; and most preferably between approximately 25 psi and approximately 1200 psi.

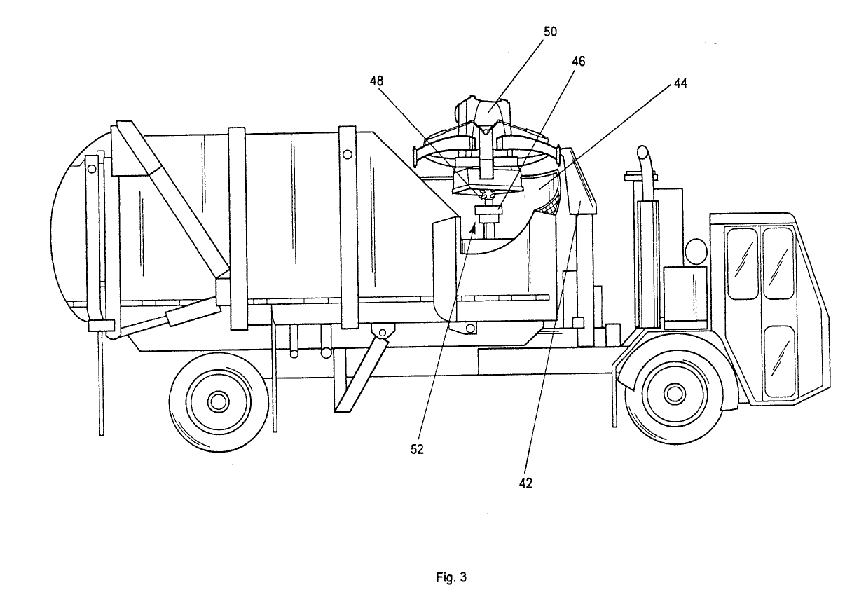

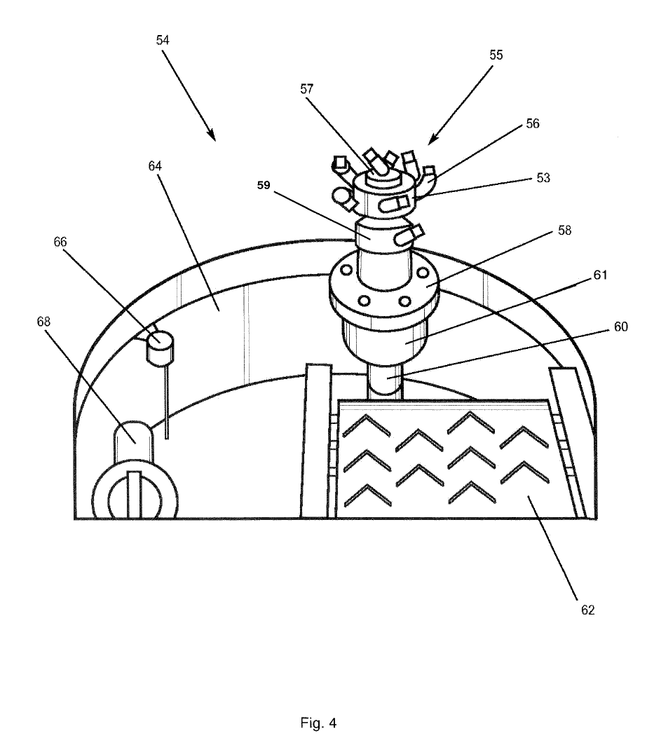

FIGS. 2 and 4 show close-up views of the spray portion of the spray system, and FIG. 3 shows inverted waste container 50 over the spray cleaning system. Spray system 32 (see FIG. 2) preferably includes rotating coupling 36. Coupling 36 is preferably made of metal(s) including but not limited to brass and stainless steel, or other heavy duty materials, with internal seals and bearings. A stationary coupling may be used as an alternative to the preferred rotatable coupling 36.

Spray head 38 and directional nozzles 34 rest on top of rotating coupling 36. Spray head 38 and nozzle 34 are preferably made of metal or other heavy duty material(s). Spray head 38 and directional nozzles 34 spin preferably between approximately 3 rpm and approximately 2000 rpm, more preferably between approximately 5 rpm and approximately 1500 rpm, and most preferably between approximately 10 rpm and approximately 1000 rpm. The fluid is delivered at a flow rate of preferably between approximately 5 gal/min and approximately 1000 gal/min (more preferably between approximately 10 gpm and approximately 800 gpm, and most preferably between approximately 15 gpm and approximately 500 gpm) to nozzles 34 through piping 40, and each nozzle 34 pressure sprays the container.

FIG. 3 depicts a typical residential waste container 50 inverted over container cleaning system 52. Container 50 is held over container cleaning system 52, and is preferably spray cleaned. When catch basin 44 fills with fluid, rotating base 46 fluid level sensor 66 (see FIG. 4) preferably activates a suction pump and the waste fluid is removed, filtered, strained and recycled. Once cleaned, waste container 50 is preferably returned to the curb via arm 42.

FIG. 4 shows a top perspective view of container cleaning system 54. Spray nozzles 56 are configured to hit the top corners or perimeter, middle and bottom of the inside of a waste container. This embodiment uses at least one spray head 55 with nozzles 56. The spray preferably has a tornado effect and is preferably designed to allow the maximum cleaning and sanitizing. Cleaning fluids may be pre-mixed, combined in a tank or divided into separate layers including but not limited to a top, middle and bottom level. Top spray nozzle layer 57 is preferably a detergent layer which contains antibacterial and antifungal components to ensure a sanitary cleansing. Other chemicals are preferably added to address different sanitary issues including, but not limited to, disinfection, deodorization, anti-odor, insects and pests. These chemicals are preferably biodegradable and environmentally friendly. Middle spray nozzle layer 53 preferably sprays a degreasing agent. Bottom spray nozzle layer 59 is preferably a water layer. The cleaning cycle is preferably sequenced (e.g. degreasing, soap and rinse) to ensure thorough cleaning. Different pipes or lines 60 are preferably attached to spray nozzle layers 53, 57, 59, and the waste fluid all goes to catch basin 64. Rotating base 61 allows for connection and rotation of spray heads. Fluid level sensor 66 detects the level of waste fluid and triggers recycling system 68 once catch basin 64 is adequately filled. FIG. 4 also shows conveyor 62, discussed in more detail below.

An embodiment of the present invention has a fluid recycling system and uses the method of recycling the fluid from the spray system after the inverted waste container has been sprayed. The fluid is preferably recycled and reused in the cleaning system. At the end of the day or run, the recycled fluid is preferably filtered and may be dumped down a sewer system and any residue or waste may be dumped at the end of the day. The filter is preferably a screen filter, and an embodiment includes but is not limited to intake and effluent valves that are used to intake fluid into the clean storage basin and remove the waste fluids and a system exhaust vent. The fluid recycling system includes but is not limited to a catch basin for catching fluid used during the spray cleaning; a filtering and separating mechanisms to separate cleaned or recyclable fluids from final waste fluids; mechanisms for reintroducing the cleaned fluid back into the clean fluid storage tank; and associated piping and pumping devices.

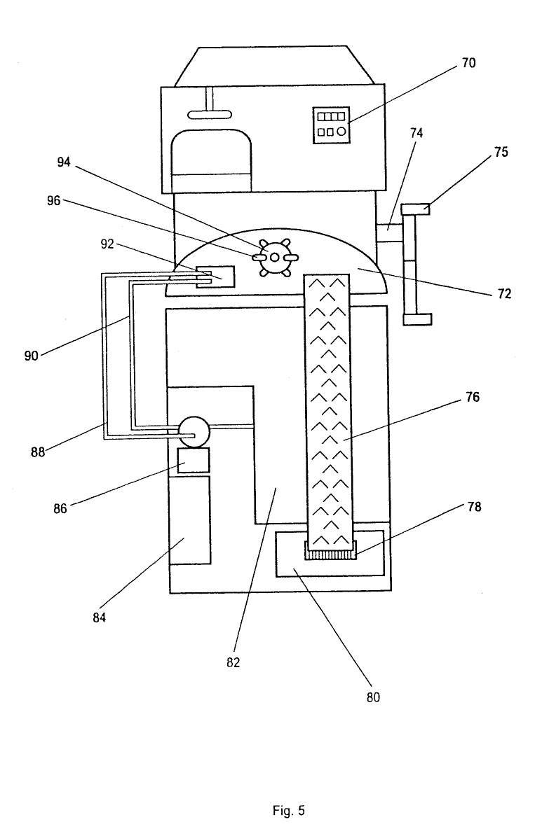

FIG. 5 is a top view schematic diagram of a container cleaning system. The container cleaning system, preferably includes (from front to back) catch basin 72, spray head 94, directional spray nozzles 96 preferably disposed on a rotating coupling, filter area and fluid level sensor 92, suction waste fluid removal piping 88, clean fluid intake piping 90, pump 86, power source 84, clean fluid storage tank 82, conveyor 76, conveyor brush 78 and residue bin 80. The driver preferably uses control box 70 to activate pump 86. Pump 86 is preferably idling until the driver activates it. Once activated, preferably through switching box 70, the fluid, preferably clean or grey fluid, is preferably pumped from clean fluid storage tank 82 through a valve. FIG. 5 also shows arm 74 and knuckle 75 for lifting, inverting and setting down the container. As the container is inverted (preferably approximately 180 degrees, but at least more than 150 degrees) it is positioned over directional spray nozzles 96 (e.g. see FIG. 3) which clean, rinse and sanitize the garbage container.

The container cleaning system preferably employs electric shut-off valves and pressure relief valves, and power source 84. Power source preferably brings in the fluid from storage tank 82 and disperses the clean fluid through spray nozzles 96. Pump 86, suction 88 and conveyor 76 are preferably left on during the entire scheduled run, and are either activated by the driver, preferably using solenoids or other control mechanisms, or are alternatively automatically activated through sensors. Power source 84 (preferably between approximately 25 hp and approximately 500 hp) drives the system and pump 86 (preferably between approximately 25 gal/min and 500 gal/min). Suction system 88 (e.g. ½″ to 6″ pipe) removes the fluid. Power source 84 may be, but is not limited to, a diesel engine, a gasoline engine or an electric engine, hydraulic motor, pneumatic motor, as appropriate to the cleaning application. Additionally, pneumatic, electric or mechanical pumps may be used as appropriate to the cleaning operation.

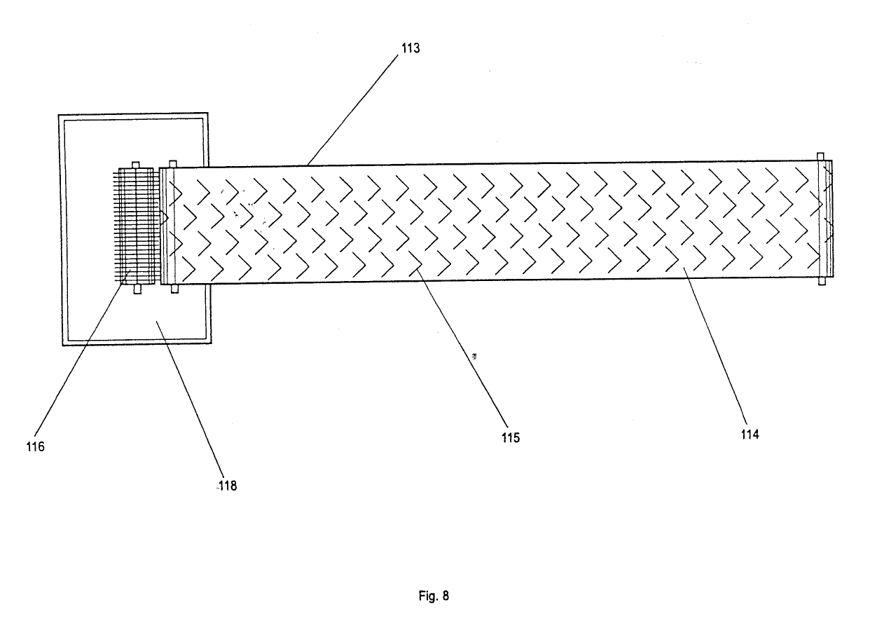

Piping 88, 90 and storage tanks 82, 80 are preferably made of metal, heavy-duty plastic, or other heavy duty materials, suitable to their purpose. Any particulate or large matter waste preferably falls onto conveyor 76 (see also FIG. 8) and is moved to the back of the cleaning system and into residue bin 80 including, but not limited to, a bin that can hold between approximately 1 cubic yd and 5 cubic yds.

The preferred embodiment has an automated loading arm. Alternative embodiments include any manual, semi-automatic, and automated lifting and tipping mechanisms. Other alternatives include but are not limited to cylindrical, chain, and frame rail, cable, track and gear, pneumatic, and screw drive lifting mechanisms.

The loading arm is preferably bendable up to 180 degrees, and usually more than 150 degrees and preferably, for inverting the container over the spray system. The inverted container aids in more complete cleaning and reduces residual liquids in the waste container. A knuckle is preferable on the loading arm for grasping and releasing the waste container. The bendable loading arm may be a side loading arm, a front loading arm or a rear loading arm. Inverting the container preferably comprises: grasping the container with a knuckle on the loading arm, lifting the container, and inverting the container up to 180 degrees (or at least 150 degrees), and holding the lid up. The container is spray cleaned and then set back down, reversing the steps of grasping, lifting and inverting.

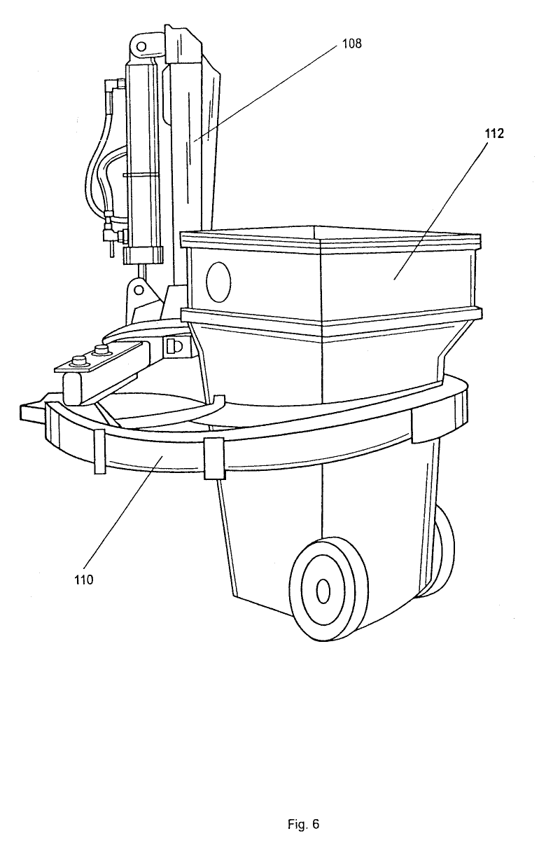

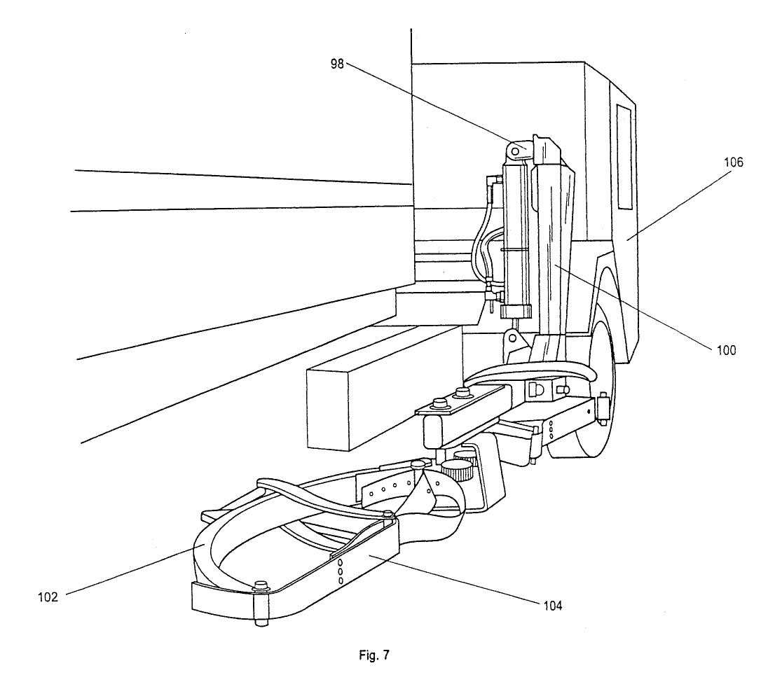

FIGS. 6 and 7 show an embodiment of arm 108 and knuckle 110 which allow for a 180 degree inversion of waste container 112 relative to its upright position while seated on the ground or other platform. In other words the 180 degree inversion means the waste container is held vertically upside down. Alternatively, the inversion may be at a lesser angle but preferably greater than 150 degrees. FIG. 7 shows arm 98 is preferably lengthened and with the joint moved. FIG. 7 shows arm 100 connected directly behind cab of truck 106 on the front portion of truck. Knuckle 102 disposed on arm 100, allows for the container to be clasped, and is preferably modified to be universal. Straps or belts 104 may be used to assist in stabilizing or securing the container. Alternative embodiments to the preferred knuckle include bushings, joints, ball-bearing mechanisms, cylinders, chains, cables, hydraulics, electrical and air mechanisms.

The arm and knuckle system are preferably able to simulate the human hand in rotation of containers or carts. The bearings and fittings of the knuckle fit in for a rotatable range of motion allowing the knuckle to grip the container and manipulate it as necessary for maximum cleaning. The knuckle is preferably attached to the arm for lifting. The knuckle is made of a set of rigid materials including but not limited to stainless steel. The arm is a rigid material with a grasping end including but not limited to clamps, belts, hoops and shoes. Alternative lifting systems may be employed as appropriate including but not limited to magnets, hooks, forklifts or any device capable of lifting a container.

The container cleaning system preferably includes a conveyor or conveyance system to transport debris away from the container. The conveyor system dumps the debris into a debris container located on the mobile vehicle. The debris container is then dumped at the end of a series of container cleanings. The debris container preferably has a rod and handle mechanism for ease of dumping. This mechanism allows for the increased safety of the handlers, and more efficient return to the cleaning.

The conveyor system is a conveying device or pumps and piping that transports the debris away from the inverted container during cleaning. It may include a brush to clean the conveying device.

FIG. 8 depicts conveyor 114 which preferably uses catch basin (see FIG. 4, 64) to “catch” the large debris from the inverted container, before and after spray cleaning. Conveyor 114 preferably has guide rail 113 and perforated chevron belt 115 on the tread of conveyor 114 to contain debris on conveyor 114 during transport to residue bin 118. Conveyor 114 is preferably made of rubber or other suitable material(s), but may also include a stepping floor or a trumbull device. Brush 116 is preferably used in conjunction with conveyor 114 to help clean and remove the waste matter from conveyor 114. Conveyor 114 is preferably slanted over catch basin (see FIG. 4, 64) and residue bin 118, to provide a gravity pull for the excess fluid and the waste/residue to fall into catch basin and waste/residue bin 118, respectively. Alternatively, any type of conveyor material or conveyor, or even a shifting floor mechanism may be used as the conveyor. The waste container cleaning system has a conveyor system which includes but is not limited to a conveyor belt, walking floor, and trumbull system. The conveyor system transports debris and/or waste away from the waste container. The most preferred embodiment of the present invention may use any appropriate conveyance mechanism including but not limited to: chain driven; direct driven; gear driven; belt; pipe transfer; grinding in pipe mechanisms; and conveyorless mechanisms or any combination thereof.

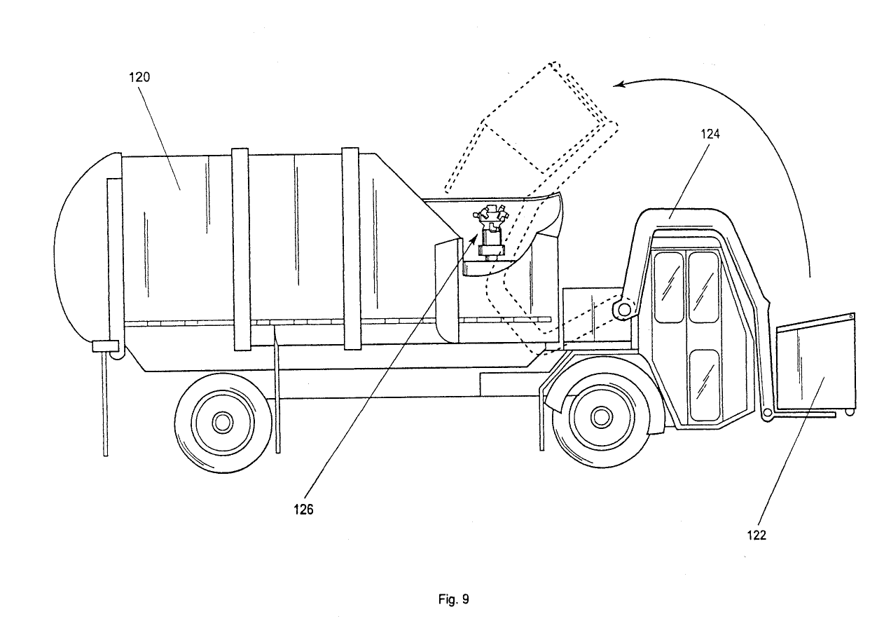

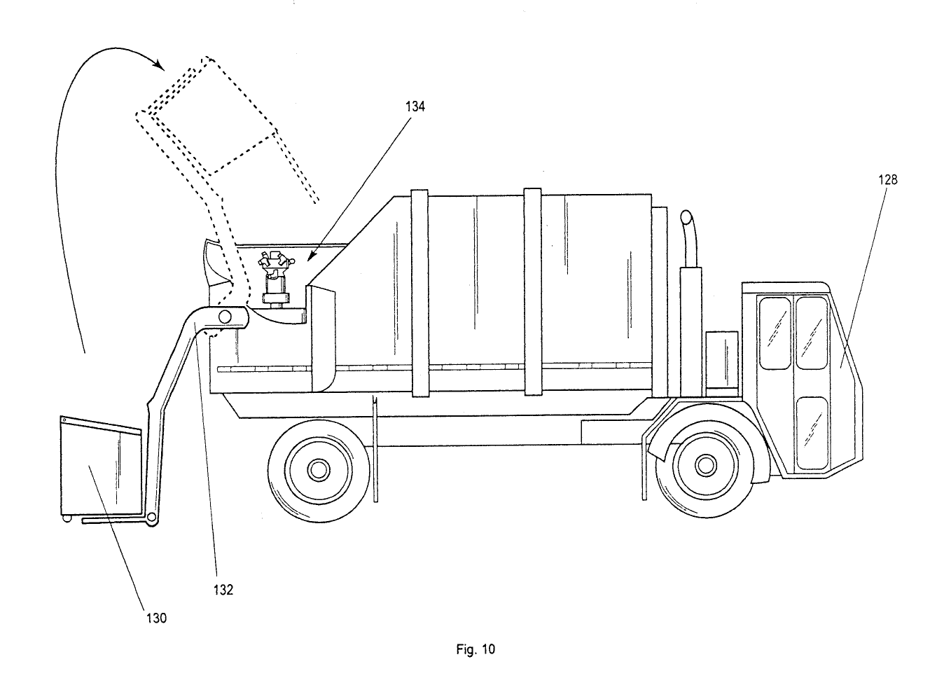

FIGS. 9 and 10 show alternative embodiments of the present invention. FIG. 9 shows front loading truck 120 with front loading arm 124 loading commercial type waste container 122 over spray cleaning system 126. FIG. 10 shows rear loading truck 128 with rear loading arm 132 loading commercial type waste container 130 over spray cleaning system 134. Alternatively, the back of the truck may be enclosed and other types of arms or lifting systems may be employed.

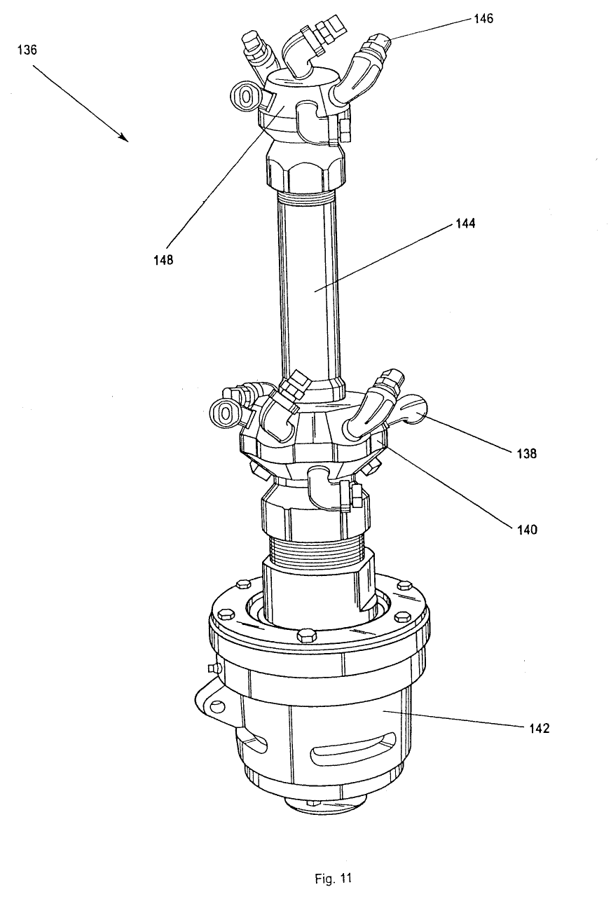

FIG. 11 shows an alternative embodiment of spray system 136 with multiple spray heads 140, 148, and pipe or connector 144. Bottom spray head 140 has top nozzle 138 removed, and connector 144 connects bottom spray head 140 to top spray head 148. Top spray head 148 has directional spray nozzles 146. Rotating coupling 142 drives the entire spray head system. Other alternative embodiments have vertical piping and single or multiple spray heads for greater surface area coverage. Spray head or spray system 148 sprays the container and preferably has at least one nozzle.

Alternative embodiments include hot water or steam systems, and mist systems that can recapture the mist for reuse. Other alternatives use solvents, chemical agents, and/or granule spray cleaning similar to sandblasting or shot peening. Additional alternatives may include a cleaning brush, wiping mechanism, and other types of spray systems. Other alternatives include electrical or sound waves, or manual cleaning mechanisms.

The container cleaning system preferably has a series water pressure system. A series or parallel water pressure system creates continuous water flow, and prevents back flow through an in-line high pressure fluid system. This type of water pressure system is a series water pressure system, where one section of the system is turned on or off “in series” with the other sections.

The in-line high-pressure system preferably has opposite pressure switches, a pop-off switch, a shut-off switch, a controlling solenoid, and a shut-down mechanism which allows the fluid spray to be turned off in seconds (preferably, less than six seconds).

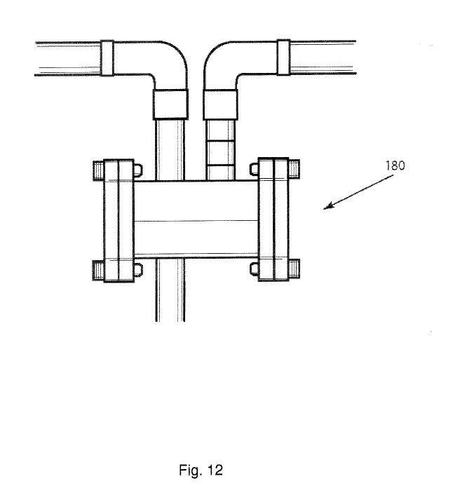

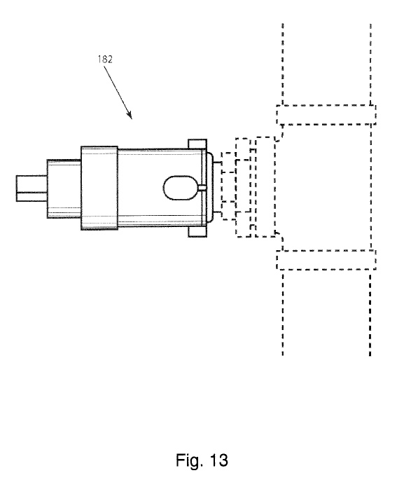

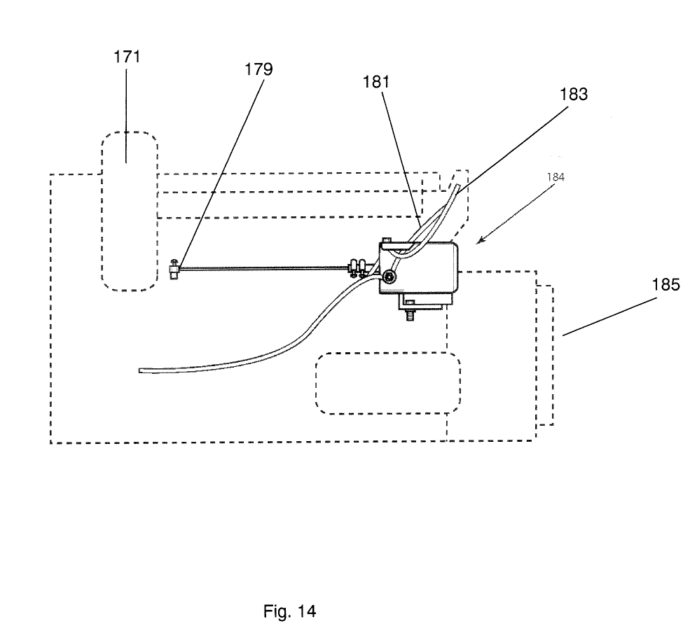

FIGS. 12 and 13 show components of an in-line high pressure system which allows for continuous fluid pressure, prevents back flow and allows for a quick shut down of the fluid spray Shut-off switch or valve 180 (FIG. 12) is mounted in the pipeline system, as is pop-off switch or valve 182 (FIG. 13). These two switches 180, 182 work as opposite switches. FIG. 14 shows solenoid 184 which controls the opposite switching system. Solenoid 184 controls the pressurized water system which can be controlled by control button or switch 179 in cab which pushes throttle 171 and accelerates the engine to pressurize water and simultaneously open water valve 185 (see also FIG. 18), which then spins the spray head on a rotatable coupling. Positive connection 181 and negative connection 183 connect to the battery for water pressure control.

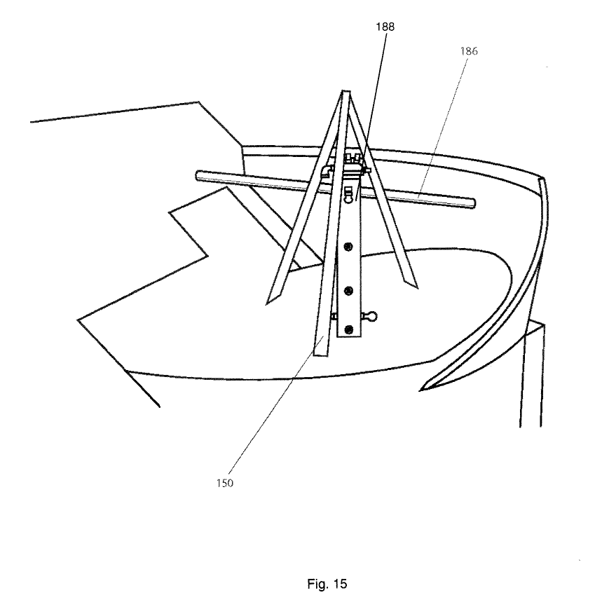

FIG. 15 shows a spray head protector 150 that is a guide for a container over the spray head and protects the spray head from damage. FIG. 15 shows the preferred guide 150 which is a tripod configuration although other configurations may be used in the present invention. Lid lifter 186 is preferably a rod which holds the container lid up while the waste container is inverted for more thorough spraying of the container. The waste containers cleaned by the waste container cleaning system may have lids. In this embodiment, the system includes a lid lifter that holds the lid up when the waste container is inverted over the spray head. One embodiment includes an automatic lid opening and closing mechanism. Arm and knuckle system (see FIG. 1, 14-16) inverts the waste container to open the lid. The lid is kept open with lid lifter 186.

Alternative embodiments include but are not limited to automatic lid opening and closing mechanisms on the lifting arm or other areas of the container cleaning system. Lid lifter 186 is a rod which can be made of metal or any hard or rigid substance, and keeps the lid of the container up while the container is inverted for spraying. Spray head protector 150 is a guide for the container to be efficiently placed over spray head and protects spray head 188 from damage.

The waste container cleaning system preferably has a fluid storage tank that uses an overflow filtration fluid system. The overflow system includes but is not limited to at least one filter, a centrifuge, separate compartments, and an agitator.

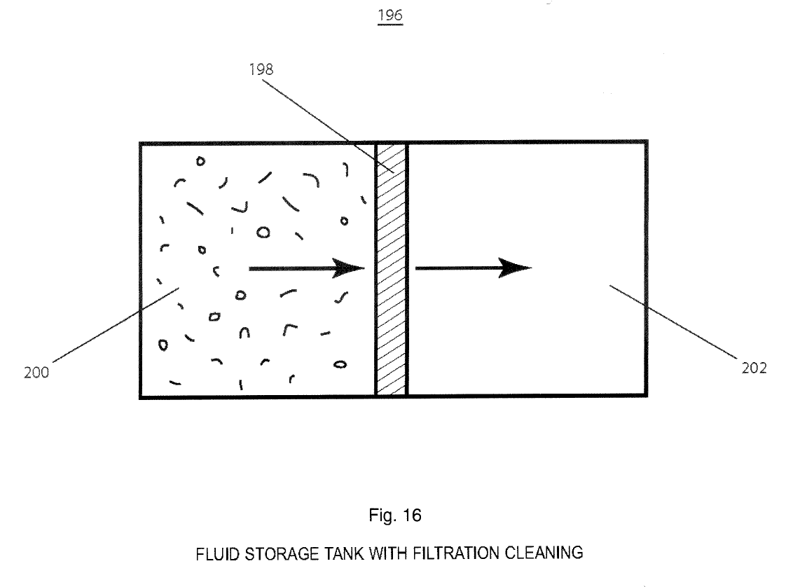

FIG. 16 shows the overflow filtration system, preferably comprising fluid storage tank 196 with filter 198. One side 200 of fluid storage tank 196 contains the dirty water or fluid collected from the rinsing of the containers. The dirty water is moved, preferably with centrifugation, and passes through filter 198. The fluid then moves to clean side 202 of fluid storage tank 196. Separate tanks may also alternatively be used to hold any of the cleaning agents, clean fluid, and waste fluid. In alternative embodiments, filters appropriate to the cleaning needs may also be used.

The waste container cleaning system fluid storage tank preferably uses premixed chemicals that clean the waste container immediately, coat the waste container and continue to be active for months (e.g., up to at least six months). The active premixed chemicals keep the waste container cleaner and allow subsequent cleanings to be more efficient.

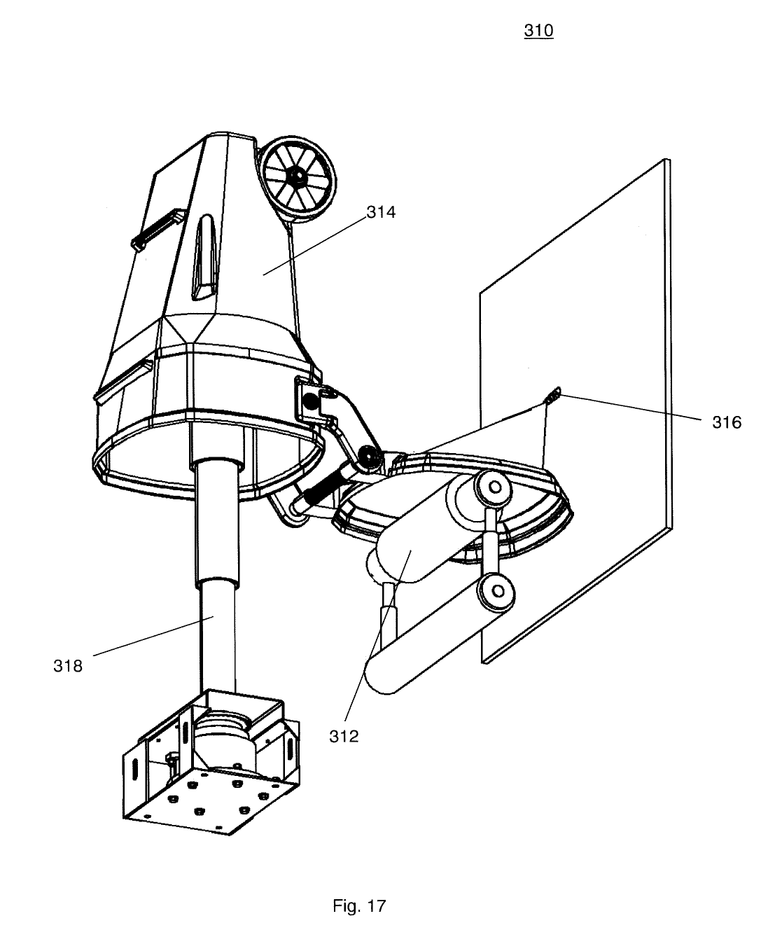

FIG. 17 is a side view of an embodiment which can clean the inside and outside of a container, preferably simultaneously. The container preferably rests at the floor of hopper during cleaning. Inside/outside system 310 utilizes external rotating foaming brush 312 (mounted to the floor of hopper) for cleaning the lid of container 314 with external high spray 316 and spray nozzle 318. An alternative embodiment may include single or multiple spray nozzles on either side of the lid for lid cleaning.

The container cleaning system is preferably mobile. Alternatively the cleaning system may be part of a garbage truck, a separate trailer or a single person mobile unit. A number of alternative embodiments are available with slight modifications to the system. The cleaning system may alternatively be employed as a stationary cleaning system at, for example, a transfer station, landfill, toxic or hazardous waste sites or active storage units, and at remediation sites.

Other alternative uses include, but are not limited to, cleaning or spraying of chemical drums, grease dumpsters (e.g. behind restaurants), rain barrels and non-uniform residential, commercial or industrial dumpsters or waste containers. The container spraying system can alternatively be used for rural areas, farms or ranches.

### INDUSTRIAL APPLICABILITY

The invention is further illustrated by the following non-limiting example.

An interior and exterior cleaning system was built and tested as described herein. The spray hopper was lined with multiple spray nozzles mounted on PVC pipe and attached to the inside of the hopper, completely surrounding the cart, and powered by a high-pressure fluid line.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents.

What is claimed is:

1. A spraying system for spraying a cart or container comprising:
a fluid spray system for spraying the cart or container, said spray system spraying both an inside and an outside of the cart or container; and
a system for lifting and inverting the cart or container over said fluid spray system.

2. The spraying system of claim 1 further comprising a mobile vehicle comprising said spraying system and a transportable base.

3. The spraying system of claim 2 wherein said vehicle comprises a switch for operating said spraying system disposed in a cab of said vehicle.

4. The spraying system of claim 3 wherein said switch is manually activated.

5. The spraying system of claim 3 wherein said switch is automatically activated.

6. The spraying system of claim 1 wherein said spraying of the inside and the outside of the cart or container is simultaneous.

7. The spraying system of claim 1 wherein said spraying of the inside and outside of the cart or container is in series.

8. The spraying system of claim 1 wherein said system for lifting and inverting comprises a system for returning the cart or container to its approximate original location.

9. The spraying system of claim 1 wherein said fluid spray system further sprays a lid of the cart or container.

10. The spraying system of claim 9 further comprising a lid lifter.

11. A method for spraying a cart or container comprising:
lifting and inverting a cart or container over a fluid spray system; and
spraying the cart or container, wherein the spray system spraying an inside and an outside of the cart or container.

12. The method of claim 11 further comprising transporting the fluid spray system via a mobile vehicle comprising a transportable base.

13. The method of claim 12 wherein the vehicle comprises a switch disposed in a cab of the vehicle and the method further comprises initiating the spraying with the switch.

14. The method of claim 13 comprising manually activating the switch.

15. The method of claim 13 comprising automatically activating the switch.

16. The method of claim 11 comprising spraying the inside and the outside of the cart or container simultaneously.

17. The method of claim 11 comprising spraying the inside and the outside of the cart or container in series.

18. The method of claim 11 further comprising spraying a lid of the cart or container with the spray system

19. The method of claim 18 further comprising lifting the lid.

20. The method of claim 11 further comprising returning the cart or container to its approximate original location.
